(19) United States
(12) Patent Application Publication
(10) Pub. No.: US 2020/0013053 A1
(43) Pub. Date: Jan. 9, 2020

(54) CONTROLLING ASSET ACCESS BASED ON PAYMENTS VIA A DISTRIBUTED LEDGER

(71) Applicant: Chaitanya Tushar AMIN, Wcaldrunn (DE)

(72) Inventor: Chaitanya Tushar AMIN, Wcaldrunn (DE)

(21) Appl. No.: 16/029,370

(22) Filed: Jul. 6, 2018

(51) Int. Cl. G06Q 20/38; H04L 9/08; H04L 29/06; G06F 17/30

(52) U.S. Cl. CPC G06Q 20/3829; H04L 9/0861; H04L 2209/56; G06F 17/30185; H04L 2209/38; H04L 63/10

(57) ABSTRACT

A computing system securely controlling repayment of a loan to purchase an asset is provided. The system records a smart contract in a distributed ledger. The smart contract receives funding messages from a lender. After purchase of the asset is funded, the system sends a payment message to the smart contract indicating that the asset is being accessed and identifying a payment transaction that transfers a payment amount to a payment account. The smart contract records in the distributed ledger a repayment transaction that transfers a repayment amount to the lender from the payment amount of the payment transaction. The smart contract ensures use of the asset in accordance with terms of the loan agreement.

### BACKGROUND

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key (or a hash of the public key, referred to as an “address”) of the new owner, is digitally signed by the owner with the owner's private key to transfer ownership to the new owner, as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

The bitcoin system is an example of a blockchain-based distributed ledger system. Other blockchain-based distributed ledger systems include Ethereum, Litecoin, Ripple, IOTA, and so on, which each support a type of cryptocurrency. To enable more complex transactions than the bitcoin system can support, some distributed ledger systems use “smart contracts.” A smart contract is computer code that implements transactions of a contract. The computer code may be executed in a secure platform (e.g., an Ethereum platform, which provides a virtual machine) that supports recording transactions in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide on which transactions to keep and which transactions to discard.

“Wallet” software has been developed to help users of the bitcoin system to generate and store their public and private key pairs, submit transactions to be recorded in the blockchain, and track their account balances by their addresses, each address being, as described above, a hash of a public key of a public and private key pair of a user. For example, wallet software may list for each address the amount of unspent bitcoin associated with that address. Because a user's private key is needed when the user spends bitcoin that the user owns, users need to ensure that their private key is neither stolen nor lost. If their private key were stolen, then the thief could transfer the bitcoin assigned to the address of the corresponding public key to the thief's own address—meaning that the thief now owns the bitcoin. If a user's private key is lost, then the user could not spend the bitcoin assigned to the address of the corresponding public key—meaning that the user has effectively lost the bitcoin. Wallet software can provide mechanisms to help ensure that the private keys are neither stolen or lost.

Because most commerce is conducted using fiat currency rather than cryptocurrency, exchange organizations have been established to exchange cryptocurrency to fiat currency, and vice versa. For example, to exchange bitcoin for fiat currency, the owner of the bitcoin would transfer an amount of bitcoin to the exchange organization. The exchange organization would then determine the current exchange rate and credit a bank account (or other account) of the user with an amount of fiat currency corresponding to the amount of bitcoin, less a service fee. The user can then spend the fiat currency in their bank account.

Computing systems are used extensively in the financial industry to run wide range of financial applications. Indeed, the initial growth of the computer industry in the mid-1900 was spurred in large part because of computing systems and financial applications provided by companies such as IBM. Because of the sensitive nature of financial information, these financial applications employ increasingly sophisticated security techniques (e.g., firewalls, private/public key pairs, encryption, token-based access, and distributed databases) to help ensure the security of such sensitive information. These financial applications also support increasingly complex financial transactions. It is, of course, important for such financial applications to also operate in a computationally efficient manner so that these financial applications can provide timely support (e.g., real-time) with minimal computational resources.

Financial applications can also help reduce the risk of the parties involved in financial transaction. As a very simple example, a check processing application of a bank may ensure that a payor's checking account has sufficient funds to cover a check before the payee is paid in cash, which help reduce the risk to the bank. Financial applications have, however, been unable to minimize some risks. For example, when a lender loans money to a borrower for the purchase of an asset, the lender has a risk if the borrower cannot pay back the money according to the terms of the loan agreement. To help reduce the risk, the lender typically has the right to take control of the asset if the borrower does not repay the money. If a person borrows money from a bank to purchase an automobile and the persons defaults on the loan, the bank may have the right to repossess and sell the automobile to help repay the loan. The repossessing and selling of automobiles or other assets can be both difficult to execute and expensive. For example, the bank may not be able to determine the location of the automobile to affect the repossession. As a result, the bank may be forced to bring legal action to recoup its unpaid amounts and the cost of the attempted repossession. Not all assets are as easy as an automobile to repossess. For example, if a hospital borrows several million dollars to purchase equipment for a new medical screening facility, it may be difficult to repossess large equipment such as a MRI machine that is difficult to disassemble and virtually impossible to repossess equipment without affecting patient lives. Moreover, even if the equipment could be repossessed, it may very difficult to sell such repossessed medical equipment. Because of the difficulty in dealing with defaults on loans and especially with assets that are difficult to repossess, some potential borrowers may find it difficult to find lenders who are willing to loan to them and if such lenders could be found, the lenders may require large down payments and high interest rates.

### BRIEF DESCRIPTION OF THE DRAWINGS

FIG. 1 illustrates a user interface for establishing a loan agreement that specifies terms for controlling access to an asset in some embodiments.

FIG. 2 illustrates a user interface for potential lenders to identify loans that are not yet funded and to submit funding offers in some embodiments.

FIG. 3 is a block diagram that illustrates the overall loan proposal, funding, and repayment processing in some embodiments.

FIG. 4 is state diagrams that illustrate the states of a smart contract and a controller device in some embodiments.

FIG. 5 is a block diagram that illustrates components of the various computer systems of and that interface with the AACS in some embodiments.

FIG. 6 is a flow diagram that illustrates the processing of a component of a smart contract that processes a funding offer message received from a potential lender.

FIG. 7 is a flow diagram that illustrates the processing of a component of the smart contract when a purchase message is received.

FIG. 8 is a flow diagram that illustrates the processing of a component of the smart contract processes a paid access message in some embodiments.

FIG. 9 is a flow diagram that illustrates the processing of a record repayment component of a smart contract in some embodiments.

FIG. 10 is a flow diagram that illustrates the processing of a check for paid off component of a smart contract in some embodiments.

FIG. 11 is a flow diagram that illustrates the processing of a component of a smart contract that processes an unpaid access message in some embodiments.

FIG. 12 is a flow diagram that illustrates the processing of a component of a smart contract that processes a unpaid access payment message in some embodiments.

FIG. 13 is a flow diagram that illustrates the processing of an access component of a controller device in some embodiments.

FIG. 14 is a flow diagram that illustrates the processing of a record payment transaction component of a controller device in some embodiments.

FIG. 15 is a flow diagram that illustrates the processing of an enter grace period component of a controller device in some embodiments.

FIG. 16 is a flow diagram that illustrates the processing of a grace/suspend component of a controller device in some embodiments.

FIG. 17 is a flow diagram that illustrates the processing of a pay for grace access component of a controller device in some embodiments.

### DETAILED DESCRIPTION

A method and system for controlling access to an asset via payments recorded in a distributed ledger is provided. In some embodiments, an asset access control system (“AACS”) includes a controller subsystem that controls access to an asset and a smart contract subsystem that coordinates payments based on accesses to the asset. The controller subsystem includes a controller device associated with the asset (e.g., a component of the asset) that directs payments to be made via a distributed ledger based on accessing (e.g., using) the asset and may prevent access to the asset when a payment cannot be made. The smart contract subsystem controls the recording in the distributed ledger of a smart contract that coordinates distribution of payments made for accessing the asset. When the asset is to be accessed, the controller device records a payment transaction with a payment amount in the distributed ledger, sends a payment message to the smart contract, and authorizes access to the asset. When the smart contract receives the payment message, the smart contract may record a further payment transaction that distributes the payment amount to one or more parties in accordance with the terms of the smart contract. For example, the asset may be a Magnetic Resonance Imaging (“MRI”) machine that is installed in a hospital. The MRI machine may be configured to interface with the controller device in such a way that the MRI machine cannot be used without authorization from the controller device. The controller device thus acts as a locking mechanism to prevent use of the device without authorization. The controller device may include an Internet of Things (“IoT”) device, such as one based on the Samsung Artik IoT Platform, that provides secure storage of private keys, secure execution of code, and so on.

In some embodiments, the AACS may be used to coordinate funding of a loan for a borrower to purchase an asset and repayment of the loan based on uses of the asset. A smart contract may be used to coordinate the funding of the loan. The smart contract implements a loan agreement between one or more lenders and one or more borrowers for purchasing an asset to be used by a borrower or, more generally, the using entity. A facilitator (e.g., a business entity) may assist borrowers in recording smart contracts tailored to each borrower's purchasing needs, publicizing unfunded loans to potential lenders, coordinating offers by lenders to fund loans, coordinating payment for the asset, configuring a controller device to control access to the asset, and so on. When a lender wants to fund (e.g., partially or fully) a loan, the lender may use the smart contract subsystem (e.g., a web page provided by the facilitator) to submit an offer to fund the loan. The smart contract subsystem may send messages to and receive messages from the smart contract to determine whether the offer to fund the loan complies with the terms of the loan agreement. For example, the loan agreement may have terms specifying a minimum funding amount; that the lender cannot be anonymous, a resident of certain jurisdictions, or an excluded entity; and other terms requiring compliance. When a funding offer is determined to be compliant, a funding message may be sent to the smart contract that defines the offer (e.g., offer amount, lender identity, and offer expiration time). Upon receiving a funding message, the smart contract may ensure again that the offer complies with the terms of the loan agreement and if so, records a funding transaction in the in distributed ledger (e.g., by directing nodes of a blockchain system to add the transaction to a block). When a smart contract records a funding transaction that results in the loan being fully funded, the smart contract transitions from a “funding” state to a “funded” state.

In some embodiments, prior to sending a funding message, a lender may use the smart contract subsystem to transfer the funds to an escrow account that is controlled by an escrow entity such as the facilitator or the smart contract. One of the terms of the loan agreement may be that the funds are to be transferred to the escrow account prior to acceptance of a funding offer. The funds may be provided via a fiat currency, a cryptocurrency, tokens, and so on. The facilitator may create AACS tokens that each represents a certain amount of funds, such as U.S. dollars. To fund a loan, a lender may be required to purchase AACS tokens (e.g., using fiat currency) from the facilitator or another entity (e.g., a potential or past lender). When an AACS token is purchased, a transaction is recorded in the distributed ledger to transfer the AACS token from an account of the seller to the account of the purchaser (e.g., potential lender). Each account may be identified by an address that is derived from (e.g., hash of) the public key of a private/public key pair of the account holder. When a lender is to send a funding message, the lender records a transaction in the distributed ledger to transfer the AACS tokens to fund the loan from the account of the lender to the escrow account. The facilitator may provide an exchange for exchanging fiat currency for AACS tokens and vice versa.

In some embodiments, the smart contract may periodically execute to check whether the terms of the loan agreement relating to funding or the terms of a funding offer have been satisfied. For example, a loan agreement may specify a term that if the loan is not sufficiently funded (e.g., fully funded) by a certain date, the loan agreement terminates and the amount of any partial funding is to be returned to the lenders. Similarly, a funding offer may specify terms such as an expiration time of the offer, a minimum funding percentage of a desired loan amount that must be achieved, and so on. When a term of the loan agreement or the funding offer is not satisfied, the smart contract may record a refund transaction that transfers the funds from the escrow account back to the account of the lender and sends a refund message to the lender and the borrower. The smart contract may then transition to an “unfunded” state.

In some embodiments, when the loan is considered to be funded, the smart contract sends a message notifying the parties (e.g., the facilitator, the borrower, the seller of the asset, and the lenders). When funded, the facilitator may coordinate the purchase of the asset using the funds held in the escrow account. The facilitator may exchange the AACS tokens held in the escrow account to a fiat currency and pay the seller of the asset on behalf of the borrower. Alternatively, if the seller of the asset accepts AACS tokens, then the smart contract may record a transaction that transfer the AACS tokens from the escrow account to the account of the seller. Prior to paying the seller or delivery or first use of the asset, the seller or borrower may be required to allow the smart contract to interact with the controller device associated with asset to provide AACS configuration information, such as the computer code that the controller device is to execute, the terms of the loan agreement, identification of the smart contract, and so on. For example, the smart contract may initially make a partial payment (e.g., 25%) to the seller; after the controller device is configured, the smart contact may make another partial payment; and after the asset is accepted by the borrower, the smart contract may make the final payment. The smart contract then transitions to a “paying” state.

After the asset is delivered or otherwise ready to access, the controller device controls access to the asset in accordance with its AACS configuration information. According to the terms of the loan agreement, the borrower may be required to pay for each use of the asset with AACS tokens. The borrower may purchase AACS tokens that are transferred to an access account under control of the controller device and possibly co-controlled by the borrower. When the asset is to be accessed, the controller device determines whether the access account has sufficient AACS tokens (as specified by the loan agreement) to pay for the access of the asset. If so, the controller device records in the distributed ledger a payment transaction that transfers the payment amount of AACS tokens from the access account to a payment account controlled by the smart contract and sends of an access message to the smart contract. The controller device then authorizes access to the device. For example, the controller device may send an authorized access message to a computing device of the asset so that the computing device can allow the access. If the asset is an MRI, the computing device may then display the normal user interface for controlling the MRI. If the asset is a bridge that is financed by the lenders, then the computing device may open an access gate. If the asset is an automobile or a building, then a door may be unlocked.

Upon receiving the access message, the smart contract may perform a repayment calculation to determine the share, also referred to as a repayment amount, of the payment amount that should be transferred to each lender (and possibly the facilitator). The smart contract then records a transaction that transfers the appropriate repayment amount to each lender. This process of repaying lenders continues until the loan is paid off according to the terms of the loan agreement. At that time, the smart contract may direct the sending of new configuration information to the controller device associated with the asset to configure the controller device to transfer unfettered control of the asset to the borrower. The smart contract then transitions to a “paid off” state.

Embodiments of the AACS may employ many different techniques for paying for access to an asset. For example, the controller device may authorize a group of accesses and then send a single payment message (e.g., once a day) to the smart contract that pays for all the accesses. If the access account does not include sufficient AACS tokens to cover payments for the accesses, the controller device may subsequently not authorize any accesses until sufficient AACS tokens are in the access account. Similarly, the smart contract may group payments, and then record a repayment transaction (e.g., once a day) covering all the payments.

In some embodiments, the AACS may employ different accounts and different messages to implement different variations. For example, a smart contract may be implement so that an access account to store AACS tokens is not needed. In such a case, a borrower may initially transfer AACS tokens to the payment account, rather than to an access account then to a payment account. In such a case, the controller device may ensure that the payment account has sufficient tokens to for an access, send an access message to the smart contract, and authorize access to the asset. Upon receiving an access message, the smart contract would then record a repayment transaction to repay the lenders the appropriate repayment amounts from the payment account. The borrower may need to periodically replenish the payment account, and any AACS tokens in the payment account may be refunded to the borrower when the loan is paid off. Such replenishment and refunding would also be employed when an access account is used.

In addition, the functions of the AACS may be implemented on different computing devices based on computational efficiency, security, cost, and so on. In particular, some functions described as being implemented on the controller device may be instead implemented by a smart contract. For example, the controller device may interact with the smart contract to determine when a loan has been paid off, when a grace period of access without payment has expired, the payment amount for an access (which may change over time based on terms of the loan agreement), and so on. As another example, the smart contract may not be involved with receiving of funding offer for the loan. Rather, a computer system under control of the facilitator may control the receiving of and processing funding offers. Also, a single controller device may control access to multiple assets such as all the assets in a laboratory. In such a case, the controller device may be a computer dedicated to control the assets subject to the same loan agreement or assets subject to different loan agreement with different smart contracts. The computer may send authorization instructions to each asset via a wired or wireless communications channel.

In some embodiments, the AACS may be implemented on a variety of distributed ledgers that may be a blockchain or not a blockchain. For example, the AACS may be implemented using an Ethereum blockchain, or a non-blockchain distributed ledger that uses a notary to notarize transactions. The distributed ledger may be public or permissioned. Also, when the distributed ledger is a blockchain, various consensus algorithms may be used such as proof of work, proof of stake, proof of authority, and so on.

Although the AACS is describe primarily in the context of repaying a loan to purchase an asset, the AACS can be used in many other contexts. The AACS may be used to implement for a pay for use or pay for purchase context. For example, in a pay for use context, a person may have an AACS “debit” card associated with the person's account having AACS tokens. To use an asset (e.g., car wash), the person provides their AACS debit card to the controller device for the asset, the controller device coordinates the transfer of AACS tokens from the person's account to a payment account, sends an access message to the smart contract for the asset, and authorizes access to the asset. Upon receiving the access message, the smart contract may transfer the AACS token of the payment account to accounts of owners of the asset in accordance with terms of the smart contract.

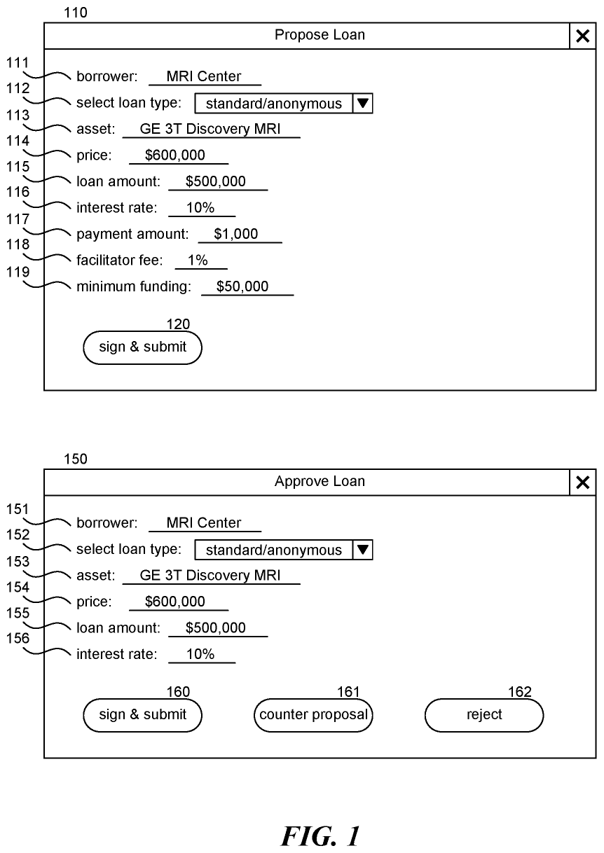

FIG. 1 illustrates a user interface for establishing a loan agreement that specifies terms for controlling access to an asset in some embodiments. A propose loan display page 110 provides an interface for allowing a borrower to propose a loan for approval by a facilitator. A propose loan display page includes a borrower field 111, a loan type field 112, an asset field 113, a price field 114, a loan amount field 115, an interest rate field 116, a payment amount field 117, a facilitator fee field 118, a minimum funding field, 119, and a sign and submit button 120. The borrower enters their identification information into the borrower field. The borrower uses a drop-down list provide by the loan type field to select the type of loan agreement for the loan. For example, the facilitator may create different types of loan agreements and the supporting programs for the smart contract and controller devices that implement each type of loan agreement. Different types of loan agreements may have different requirements such as requiring the lenders to be identified, limiting the number of lenders, addressing various jurisdictional requirements, providing required reporting, supporting different types of asset classes, and so on. The borrower uses the asset field to identify the asset for which the funds are being borrowed. In this example, the asset is a GE 3T Discovery MRI. The borrower uses the price field to enter the price of the asset. The borrower uses the loan amount field to enter the desired loan amount. The borrower uses the interest rate field to enter the interest rate to be paid on the borrowed funds. The borrower uses the payment amount field to enter the amount that will be paid to the lenders for each access of the asset. The borrower uses the facilitator fee field to enter the fee to be paid to the facilitator. The borrower uses the minimum funding field to specify the minimum allowed funding by a lender. After the borrower enters the data for the fields, the borrower selects the sign and submit button to sign a transaction that includes information on the proposal and to notify the facilitator of the proposal. The propose loan display page may include many other fields and user interface elements to allow the borrower to develop a proposed loan. An approve loan display page 150 presents data of a loan proposal similar to that presented by the propose loan display page in read-only fields 151-159. The facilitator (or a lender or the lender's agent) can use a sign and submit button 160, a counterproposal button 161, and a reject button 162 to indicate the facilitator's decision on the loan proposal. When the facilitator selects the sign and submit button, the AACS retrieves the appropriate smart contract that implements the terms of the loan agreement and records the smart contract in the distributed ledger. The AACS may also publish loan information for potential lenders and notify the borrower. When the facilitator makes a counterproposal, the AACS may provide a user interface for outlining the terms of the counterproposal and notifying the borrower of the counterproposal. The AACS may provide a user interface for the borrower to review and accept or reject the counterproposal. When the facilitator rejects the proposal, the AACS notifies the borrower of the rejection. The facilitator may also provide a reason for the rejection.

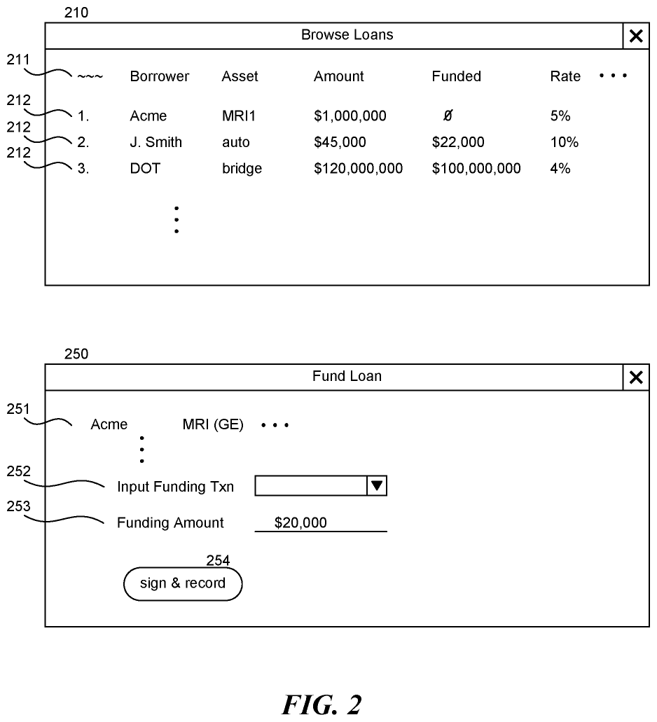

FIG. 2 illustrates a user interface for potential lenders to identify loans that are not yet funded and to submit funding offers in some embodiments. A browse loans display page 210 allows a potential lender to browse available loans that are not funded. The browse loans display page may identify information 211 such as borrower, asset, loan amount, amount funded, interest rate, and other information that may be useful for the potential lender to identify a loan to fund. Entries 212 each represents the information of a different loan. A fund loan display page 250 is displayed after a potential lender selects a loan from the browse loans display page. The fund loan display page may display very detailed information 251 about the selected loan as illustrated by the ellipses. In addition, the fund loan display page may include an input funding transaction field 252, a funding amount field 253, and a sign and record button 254. The input funding transaction field allows the potential lender to specify the transaction that outputs the AACS tokens that have been placed in the escrow account and that will be used to fund the loan. The AACS may provide a web page through which the potential lender can transfer the lender's AACS tokens to the escrow account. The funding amount field allows the potential lender to specify the funding amount, which may be the value of the AACS tokens transferred to the escrow account. When the potential lender selects the sign and record button, the AACS sends an funding offer message to the smart contract for the loan. The AACS may also provide various user interfaces for potential lenders and borrowers to review the funding status of their loans, the repayment status, and so on. The AACS may implement various permission techniques to ensure that potential lenders can only fund loans for which they are permitted to fund. For example, a certain loan agreement may specify that only entities such as banks (and not individuals) or those in certain jurisdictions may participate in the funding of the loan.

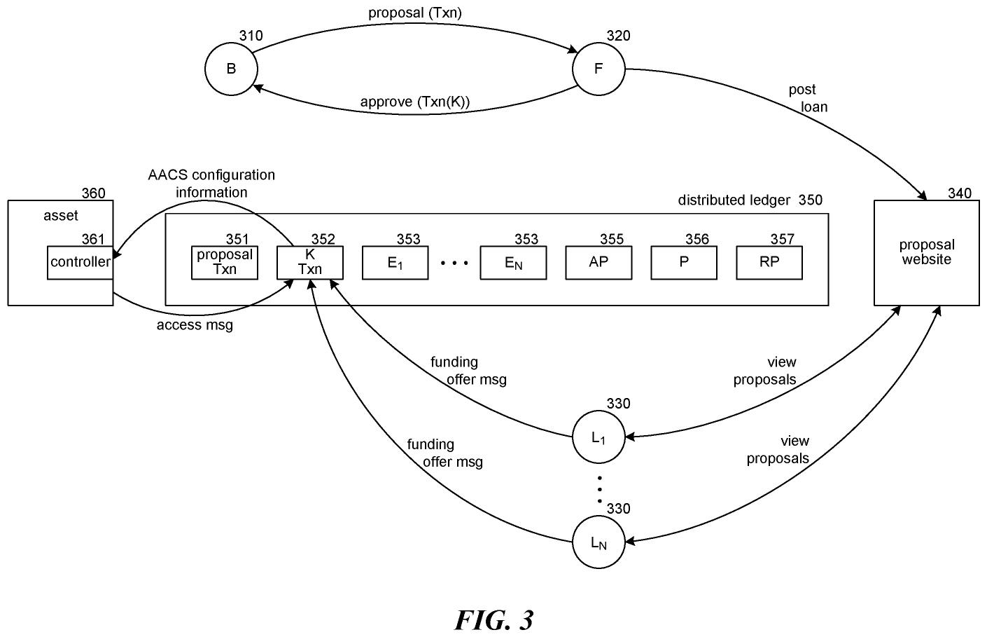

FIG. 3 is a block diagram that illustrates the overall loan proposal, funding, and repayment processing in some embodiments. A borrower (“B”) 310 initiates a loan by recording a proposal transaction 351 in distributed ledger 350 and sending a message to the facilitator (“F”) 320. When the facilitator approves the loan, the facilitator records in the distributed ledger a smart contract (“K”) via transaction 352, posts the loan to a proposal website 340 that is accessible to potential lenders, and notifies the borrower of the approval. In some embodiments, the borrower may disintermediate the facilitator and perform the steps to make the loan visible to potential lenders. The potential lenders (“Ls”) 330 view the proposals posted at the proposal website, record in the distributed ledger an escrow transaction (“E”) 353 to transfer AACS tokens to the escrow account for the loan, and send a funding offer message to the smart contract. When the smart contract determines that the loan is fully funded, the smart contract notifies the borrower, facilitator, and the lenders. The facilitator then uses the AACS tokens in the escrow account to fund the purchase of the asset. The facilitator may also coordinate the configuring of the controller device 361 for controlling access to the asset 360 in accordance with the loan agreement. Alternatively, the smart contract may send AACS configuration information directly to the controller device after being provided with addressing information (e.g., a TCP/IP address) for the controller device. Prior to using the asset, the borrower purchases AACS tokens and records in the distributed ledger an asset payment transaction (“AP”) 355 to transfer the AACS tokens to an access payment account that is controlled by the controller device. When the asset is to be accessed, the controller device records a payment transaction (“P”) 356 that transfers the payment amount of AACS tokens from the access payment account to a payment account that is controlled by the smart contract and sends an access message to the smart contract that identifies the payment transaction. Upon receiving an access message, the smart contract determines the repayment amount for each lender and records in the distributed ledger a repayment transaction (“RP”) 357 that transfers a repayment amount of the AACS tokens to each lender. Although illustrated as a single transaction, the smart contract may record a separate repayment transaction for each lender. A payment transaction and a repayment transaction may be recorded for each access or group of accesses of the asset.

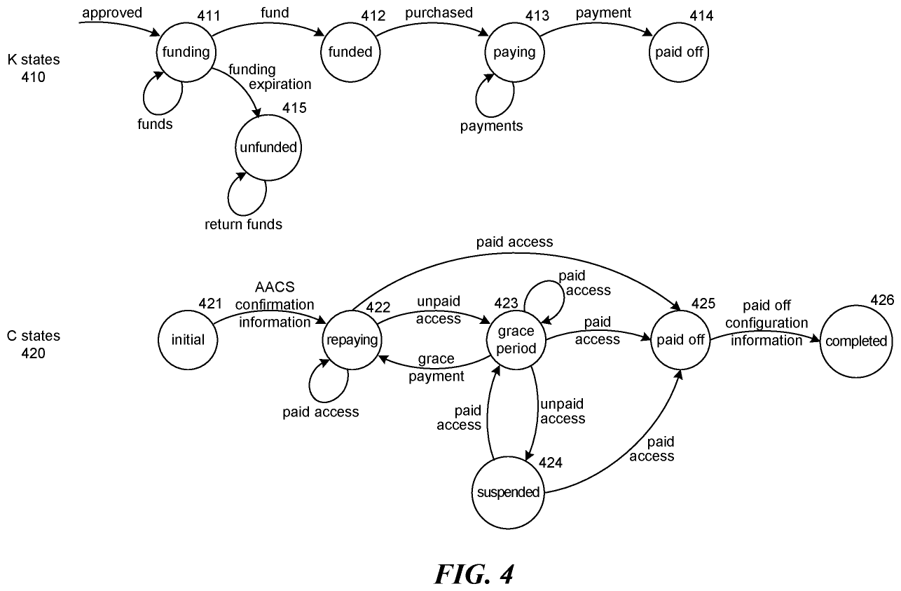

FIG. 4 is state diagrams that illustrate the states of a smart contract and a controller device in some embodiments. The smart contract states 410 include a funding state 411, a funded state 412, a paying state 413, a paid off state 414, and an unfunded state 415. When a loan is approved by the facilitator, the smart contract enters the funding state and stays in that state until it is fully funded, or it cannot be funded. If the loan cannot be funded, then the smart contract transitions to the unfunded state and directs that the funds held in the escrow account to be return to the potential lenders. When the smart contract determines that the loan is funded, the smart contract transitions to the funded state. After being notified that the asset has been purchased, the smart contract transitions to the paying state. In the paying state, the smart contract receives payments from the controller device. When the smart contract determines that the loan has been paid off, the smart contract transitions to the paid off state.

The controller (“C”) states for the controller device include an initial state 421, a repaying state 422, a grace period state 423, a suspended state 424, a paid off state 425, and a completed state 426. The controller device may be programmed to initially enter the initial state in which it waits for AACS configuration information for controlling repayment of a loan. Upon receiving the AACS configuration information, the controller device transitions to the repaying state in which the controller device sends payments for each paid access. If the access payment account does not include sufficient AACS tokens to pay for an access, then the controller device may authorize the access and transitions to the grace period state. The grace period states allow continued access to the asset without payment in accordance with the terms of the loan agreement. Depending on the type of asset, the controller device may also allow emergency access to an asset. For example, an emergency access may be needed to save the life of a person. To allow such access, a designated employee of a borrower may have an emergency code that when provided to the controller device allows for authorization to access the asset at any time irrespective the state of the controller device. If the asset is, for example, a satellite phone, then the controller device may allow emergency calls to be made to designated phone numbers. If access to the asset is requested when the controller device is in the grace period, then any paid access may be granted. If, however, an unpaid access is requested, then the controller device may transition to a suspended state in which no unpaid access will be further granted. When in the grace period state, the controller device may identify that sufficient AACS tokens have been added to the access payment account to pay for some of all the unpaid access. In such a case, the controller device may transition to the repaying state. In the repaying state, the grace period state, or the suspended state, the controller device may detect that the loan has been paid off and transition to the paid off state. The controller device may detect loan is paid off on its own or may receive a paid off message from the smart contract indicating that the loan has been paid off. For example, a loan agreement may have terms specifying that the borrower may pay off the loan by making a certain lump sum payment of AACS tokens independently of access to the asset. Upon receiving paid off configuration information when in the paid off state, the controller device sets its configuration to allow the borrower to control access to the asset and an transitions to a completed state indicating that the loan has been paid and the borrower now controls the asset.

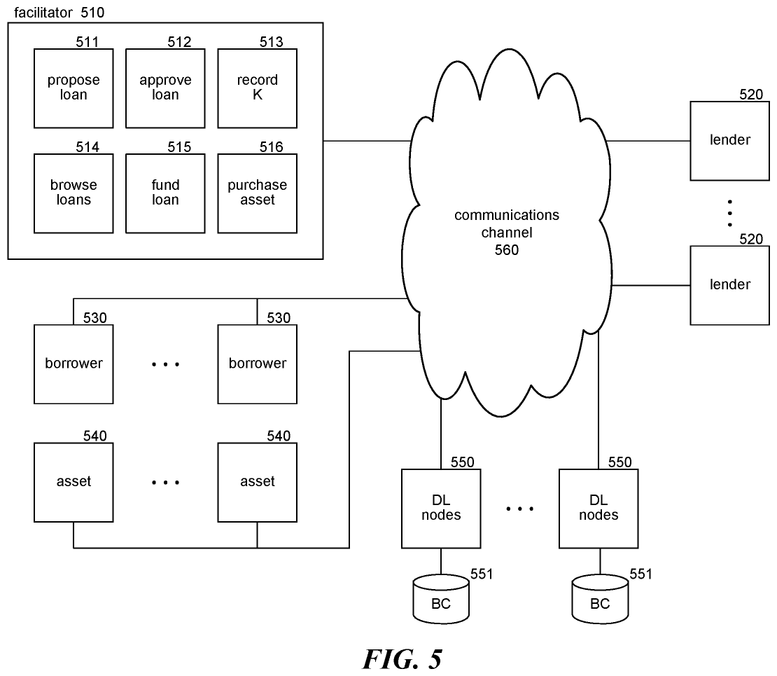

FIG. 5 is a block diagram that illustrates components of the various computer systems of and that interface with the AACS in some embodiments. The computing systems include a facilitator computing system 510, lender computing systems 520, borrower computing systems 530, assets 540, and distributed ledger nodes 550 that are connected via communications channel 560 such as the Internet. The facilitator computing systems include a propose loan component 512, an approve loan component 512, a record smart contract component 513, a browse loans component 514, a fund loan component 515, and a purchase asset component 516. The propose loan component provides the user interface for a borrower using a borrower computing system to propose a loan. The approve loan component provides the user interface for the facilitator to approve a loan. The record smart contract component records in the distributed ledger the smart contract for an approved loan. The browse loans component allows a potential lender using a lender computer system to view the loans that are available for funding and other statuses related to a loan. The fund loan component allows a potential lender to submit a funding offer to fund a loan. The purchase asset component allows the facilitator to facilitate the purchase of the asset using the AACS tokens held in the escrow account for the loan. The distributed ledger nodes may each have a copy of the blockchain computer program that implements the blockchain that is stored in blockchain stores 551.

The computing systems (e.g., nodes) on which the AACS may be implemented may include a central processing unit, input devices, output devices (e.g., display devices and speakers), storage devices (e.g., memory and disk drives), network interfaces, graphics processing units, cellular radio link interfaces, global positioning system devices, and so on. The input devices may include keyboards, pointing devices, touch screens, gesture recognition devices (e.g., for air gestures), head and eye tracking devices, microphones for voice recognition, and so on. The computing systems may include desktop computers, laptops, tablets, e-readers, personal digital assistants, smartphones, gaming devices, servers, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements the AACS. The data transmission media are used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys.

The AACS may be described in the general context of computer-executable instructions, such as program modules and components, executed by one or more computers, processors, or other devices. Generally, program modules or components include routines, programs, objects, data structures, and so on that perform tasks or implement data types of AACS. Typically, the functionality of the program modules may be combined or distributed as desired in various examples. Aspects of the AACS may be implemented in hardware using, for example, an application-specific integrated circuit (“ASIC”) or field programmable gate array (“FPGA”).

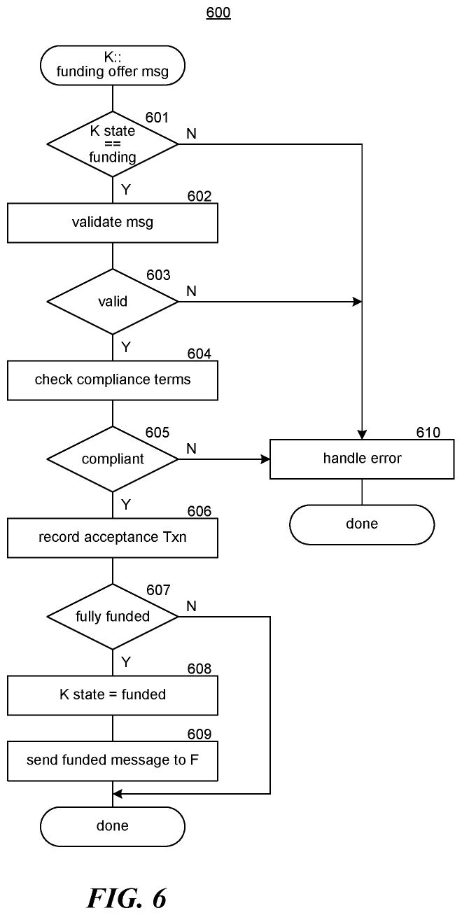

FIGS. 6-12 are flow diagrams that illustrate the processing of messages received by a smart contract in some embodiments. FIG. 6 is a flow diagram that illustrates the processing of a component of a smart contract that processes a funding offer message received from a potential lender. A funding offer message component 600 is invoked when a funding offer message is received. In decision block 601, if the smart contract state is funding, then the component continues at block 602, else the message was received when the smart contract was in the wrong state and the component continues at block 610. In block 602, the component validates the message, for example, to ensure that it is properly signed and that it identifies a transaction that transfers AACS tokens to the escrow account. In decision block 603, if the message is valid, then the component continues at block 604, else the component continues at block 610. In block 604, the component checks the offer to ensure it complies with the terms of the loan agreement, for example, as providing a minimum amount of funding or not exceeding a maximum amount funding by a lender. In decision block 605, if the funding offer is compliant, then the component continues at block 606, else the component continues at block 610. In block 606, the component may record an acceptance transaction to indicate that the funding offer has been accepted. In decision block 607, if the loan is fully funded, then the component continues at block 608, else the component completes. In block 608, the component transitions the smart contract to the funded state. In block 609, the component sends a funded message to the facilitator so that the facilitator can coordinate the purchase of the asset and then completes. In block 610, the component handles the error and refunds the AACS tokens placed in escrow as part of the offer and then completes.

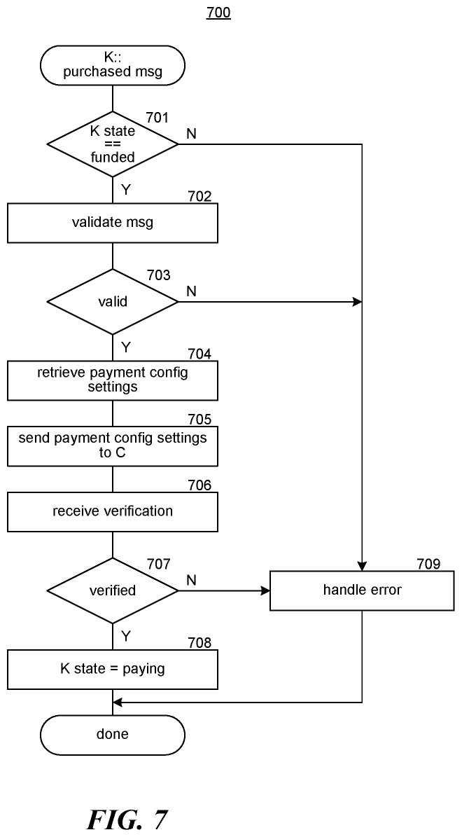

FIG. 7 is a flow diagram that illustrates the processing of a component of the smart contract when a purchase message is received. A purchased message component 700 is invoked when a purchase message is received indicating that the asset has been purchased. In decision block 701, if the smart contract state is funded, then the component continues at block 702, else the component continues at block 709. In block 702, the component validates the message. In decision block 703, if the message is valid, then the component continues at block 704, else the component continues at block 709. In block 704, the component retrieves AACS configuration information for configuring the controller device of the asset to pay for accesses. In block 705, the component sends the AACS configuration information to the controller device of the asset. In block 706, the component may receive a verification message from the controller device to indicate that it has been properly configured. In decision block 705, if a verification message is received, then the component continues at block 708, else the component continues at block 709. In block 708, the component transitions the smart contract to the paying state and then completes. In block 709, the component handles the error and then completes.

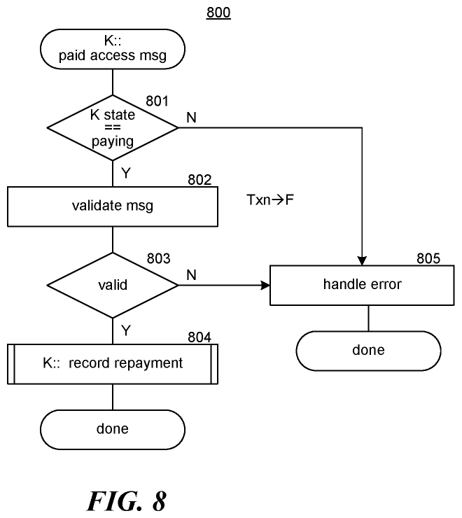

FIG. 8 is a flow diagram that illustrates the processing of a component of the smart contract processes a paid access message in some embodiments. A paid access message component 800 is invoked when the smart contract receives a paid access message. In decision block 801, the smart contract is in the paying state, then the component continues at block 802, else the component continues at block 805. In block 802, the component validates the message. In block 803, if the message is valid, then the component continues at block 804, else the component continues at block 805. In block 804, the component invokes a record repayment component to record a repayment transaction to repay the lenders based on the paid access and then completes. In block 805, the component handles the error and then completes.

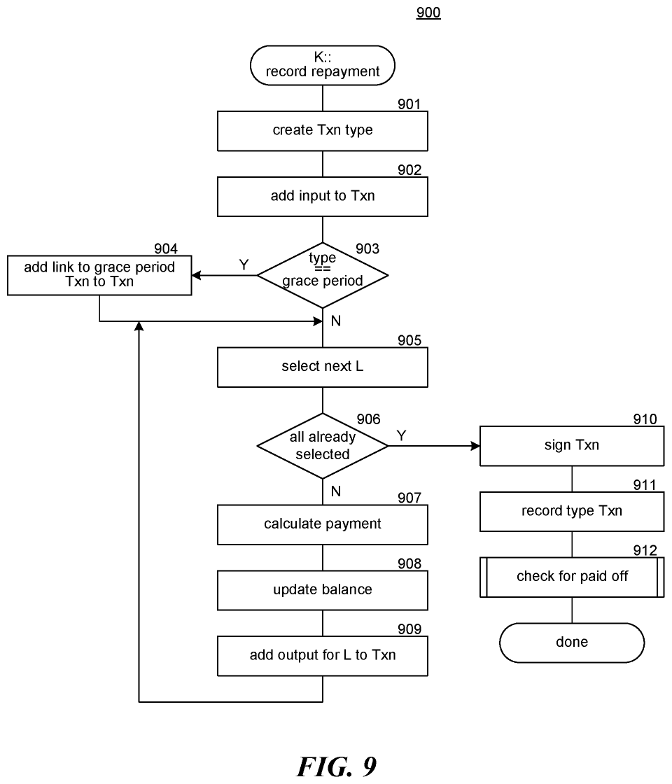

FIG. 9 is a flow diagram that illustrates the processing of a record repayment component of a smart contract in some embodiments. A record repayment component 900 is passed a type of payment (e.g., regular payment or grace period payment) being made and records a repayment transaction. In block 901, the component creates a repayment transaction that is appropriate for the type. In block 902, the component adds the input to the transaction to identify the transaction that outputs the AACS tokens of the payment account. In decision block 903, if the type of the access is a grace period, then the component continues at block 904, else the component continues at block 905. In block 904, the component may add a link to the repayment transaction to identify a unpaid access transaction representing an unpaid access during a grace period that has not yet been paid for. In block 905-909, the component adds an output to the repayment transaction for each lender. In block 905, the component selects the next lender. In decision block 906, if all the lenders have already been selected, then the component continues at block 910, else the component continues at block 907. In block 907, the component may calculate the repayment amount for the lender. The repayment amount may be fixed or may vary based on the payment amount or terms of the loan agreement. In block 9068, the component updates a remaining balance on the loan. In block 909, the component adds the output for the selected lender to the repayment transaction loops to block 905 to select the next lender. In block 910, the component signs the transaction. In block 911, the component records the repayment transaction in the distributed ledger. In block 912, the component invokes check for paid off component to determine whether the loan has been paid off and then completes.

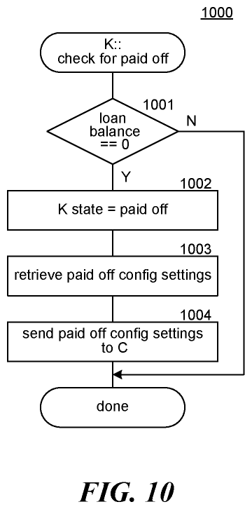

FIG. 10 is a flow diagram that illustrates the processing of a check for paid off component of a smart contract in some embodiments. A check for paid off component 1000 is invoked to determine whether a loan has been paid off. In decision block 1001, if loan balance is zero, then the component continues at block 1002, else the component completes. In block 1002, the component transitions the smart contract to the paid off state. In block 1003, the component retrieves paid off configuration information for the controller device. In block 1004, the component sends the paid off configuration information to the controller device and then completes. The component may also notify the facilitator, the lenders, and the borrower that the loan has been paid off.

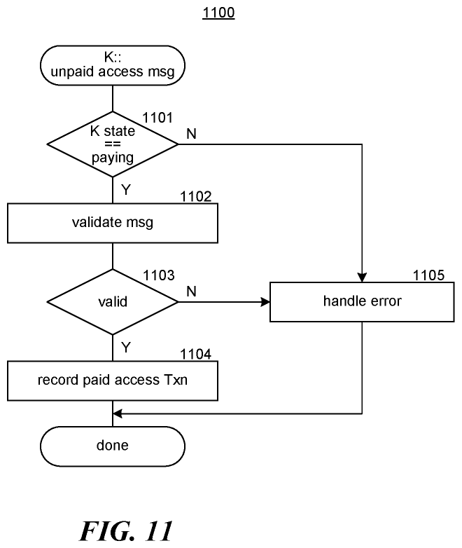

FIG. 11 is a flow diagram that illustrates the processing of a component of a smart contract that processes an unpaid access message in some embodiments. An unpaid access message component 1100 is invoked when an unpaid access message is received by the smart contract. An unpaid access message indicates that the asset has been accessed without a payment being made. In block 1101, if the smart contract state is paying, then the component continues at block 1102, else the component continues at block 1105. In block 1102, the component validates the message. In block 1103, if the message is valid, then the component continues at block 1104, else the component continues at block 1105. In block 1104, the component records an unpaid access transaction in the distributed ledger and then completes. In block 1104, the component handles the error and then completes.

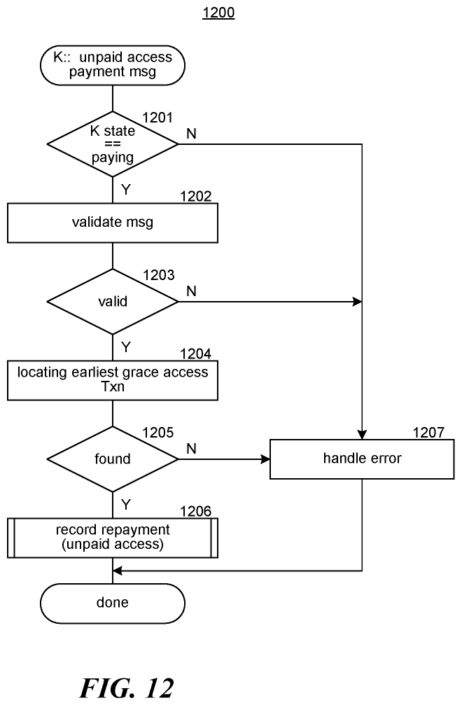

FIG. 12 is a flow diagram that illustrates the processing of a component of a smart contract that processes an unpaid access payment message in some embodiments. A unpaid access payment message component 1200 is invoked when an unpaid access payment message is received from the controller device. An unpaid access payment message indicates that the access payment account has sufficient AACS tokens to pay for previously unpaid access. In decision block 1201, if the smart contact state is the paying state, then the component continues at block 1202, else the component continues at block 1207. In block 1202, the component validates the message. In decision block 1203, the message is valid, then the component continues at block 1204, else the component continues at block 1207. In block 1204, the component locates the earliest unpaid access transaction to match it up with the current payment. In decision block 1205, if the transaction is found, then the component continues at block 1206, else the component continues at block 1207. In block 1206, the component invokes a record repayment component to record a repayment transaction for the previously unpaid access and then completes. In block 1207, the component handles the error and then completes.

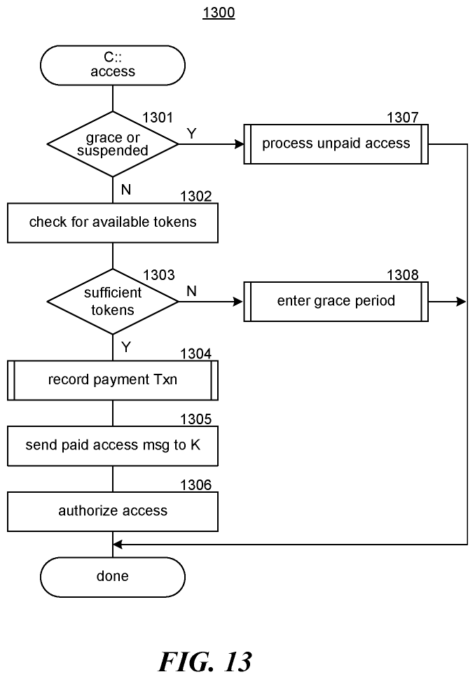

FIGS. 13-17 are flow diagrams that illustrates the processing of a controller device in some embodiments. FIG. 13 is a flow diagram that illustrates the processing of an access component of a controller device in some embodiments. An access component 1300 is invoked when a request is received to access the asset. In decision block 1301, if the state of the controller device is grace period or suspended, then the component continues at block 1307, else the component continues at block 1302. In block 1302, the component checks for available AACS tokens in the access payment account. In decision block 1303, if the AACS tokens are sufficient to pay for the access, then the component continues at block 1304, else the component continues at block 1308. In block 1304, the component invokes a record payment transaction to record in the distributed ledger a payment transaction. In block 1305, the component sends a paid access message to the smart contract. In block 1306, the component sends an authorized access message to the asset and then completes. In block 1307, the component invokes a process unpaid access component and then completes. In block 1308, the component invokes an enter grace period component and then completes.

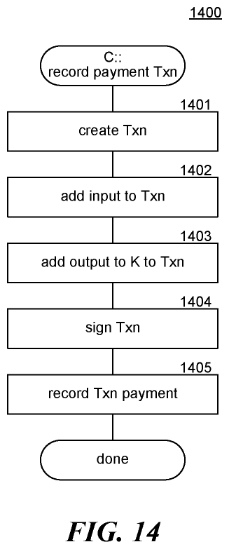

FIG. 14 is a flow diagram that illustrates the processing of a record payment transaction component of a controller device in some embodiments. A record payment transaction component 1400 is invoked to record a payment transaction to pay for an access to the asset. In block 1401, the component creates the payment transaction. In block 1402, the component adds an input to the payment transaction that is the output of a transaction in the access payment account. In block 1403, the component adds an output to transfer the payment to the payment account. In block 1404, the component signs the payment transaction. In block 1405, the component records the payment transaction in the distributed ledger and then completes.

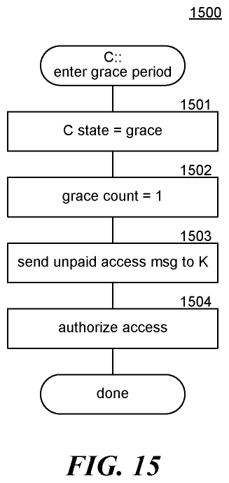

FIG. 15 is a flow diagram that illustrates the processing of an enter grace period component of a controller device in some embodiments. An enter grace period component 1500 is invoked when the controller device is to transition to the grace period because an unpaid access is authorized. In block 1501, the component transitions the state of the controller device to the grace period. In block 1502, the component sets a count of the number of unpaid access to one. In block 1503, the component sends an unpaid access message to the smart contract. In block 1504, the component sends a message to the asset to authorize the access to the asset and then completes.

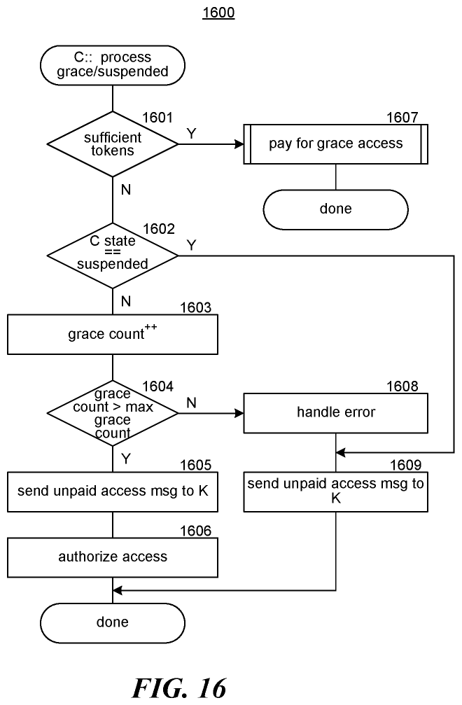

FIG. 16 is a flow diagram that illustrates the processing of a grace/suspend component of a controller device in some embodiments. A process grace/suspend component 1600 is invoked to process a request to access an asset when the controller device is in the grace period state or the suspended state. In decision block 1601, if the access payment account has sufficient AACS tokens, then the component continues at block 1607, else the component continues at block 1602. In block 1602, if the controller device is in a suspended state, then the component continues at block 1609, else the component continues at block 1603. In block 1603, the component increments the grace count. In decision block 1604, if the grace count is greater than a maximum grace count (e.g., specified by the loan agreement), then the component continues at block 1608, else the component remains in the grace period state and continues at block 1605. In block 1605, the component sends an unpaid access message to the smart contract. In block 1606, the component sends a message to the asset to authorize access to the asset. In block 1607, the component invokes a pay for grace access component and then completes. In block 1608, the component transitions the state of the controller device to suspended. In block 1609, the component sends a suspended message to the smart contract and then completes.

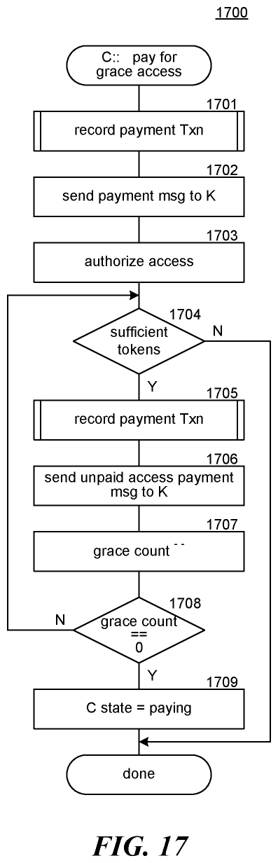

FIG. 17 is a flow diagram that illustrates the processing of a pay for grace access component of a controller device in some embodiments. The pay for grace access component 1700 is invoked when in the grace period and there are sufficient AACS tokens to pay for an access. In block 1701, the component invokes a record payment transaction component to record a payment transaction. In block 1702, the component sends a payment message to the smart contract. In block 1703, the component sends a message to the asset to authorizes access to the asset. In blocks 1704-1709, the component pays for previously unpaid accesses if there are sufficient AACS tokens in the access payment account. In decision block 1704, if there are sufficient AACS tokens, then the component continues at block 1604, else the component completes. In block 1705, the component invokes the record payment transaction component to record a payment transaction. In block 1706, the component sends an unpaid access payment message to the smart contract. In block 1707, the component decrements the grace count. In decision block 1708, if the grace count is zero, then all the unpaid accesses have been paid off and the component continues at block 1709, else the component loops to block 1704 to determine whether another unpaid access can be paid. In block 1709, the component transitions the controller device date to a paying state and then completes.

The following paragraphs describe various embodiments of aspects of the AACS. An implementation of the AACS may employ any combination of the embodiments. The processing described below may be performed by a computing device with a processor that executes computer-executable instructions stored on a computer-readable storage medium that implements the AACS.

In some embodiments, a method performed by a computing system for securely controlling repayment of a loan to purchase an asset is provided. The method records a smart contract in a distributed ledger. The smart contract identifies a loan amount for purchase of the asset and terms of a loan agreement. The method receives by the smart contract a plurality of funding messages from lenders. Each funding message identifies a funding amount and an escrow transaction that transfer the funding amount to an escrow account. The method receives, by the smart contract from a controller device associated with the asset, a payment message indicating an access to the asset and identifying a payment transaction that transfers a payment amount to a payment account. The method records by the smart contract in the distributed ledger a repayment transaction that transfers a repayment amount to one or more lenders from the payment amount of the payment transaction. In some embodiments, the smart contract transitions through a funding state, a funded state, a repaying state, and a paid off state. In some embodiments, the controller device ensures use of the asset in accordance with terms of the loan agreement. In some embodiments, the payment account is identified by an address of a private/public key pair of the smart contract. In some embodiments, the payment account is identified by an address of a private/public key pair of a facilitator who records the smart contract. In some embodiments, the amounts are represented by tokens that can be exchanged for a currency. In some embodiments, the method further, when the loan amount is not funded in accordance with terms of the loan agreement, records by the smart contract in the distributed ledger a refund transaction for each lender that transfers the escrow account a funding amount for that lender to an account of the lender.

In some embodiments, a method performed by a controller device associated with an asset for coordinating repayment of a loan for purchase of the asset is provided. The method accesses configuration information for directing repayment of the loan based on access to the asset. The method receives an identification of an access payment transaction of an access payment account. In response to receiving an indication of access to the asset, the method records in a distributed ledger a payment transaction that transfers a payment amount from the access payment transaction to a payment transaction of a payment account. The method sends a payment message to a smart contract that implements terms of loan agreement for the loan so that the smart contract can direct recording of a repayment transaction to transfer a repayment amount from the payment transaction to lender account of a lender of the loan. In some embodiments, the configuration information includes a private key of a private/public key pair for the access payment account that is used to sign the payment transaction. In some embodiments, the method further, in response to the loan being paid off, activates paid off configuration information wherein the controller device no longer is required to record payment transactions. In some embodiments, the paid off configuration information enables full control by the borrower of the now-paid off asset. In some embodiments, the method further when a payment transaction is identified that includes a payment amount that is sufficient, authorizes access to the asset. In some embodiments, the authorizing results in disabling of a locking mechanism that prevents access to the asset. In some embodiments, the method further when an access payment transaction is not identified that includes a payment amount that is sufficient, does not authorize access to the asset. In some embodiments, the method further when an access payment transaction is not identified that includes a payment amount that is sufficient, transitions to a grace period state and authorizing access to the asset. In some embodiments, the method further in response to receiving an indication of a subsequent access to the asset when in the grace period state and when a second access payment transaction is identified that includes a payment amount that is sufficient, records in the distributed ledger a second payment transaction that transfers a payment amount from the second access payment transaction the payment account; sends a second payment message to the smart contract that implements terms of the loan agreement so that the smart contract can record a second repayment transaction to transfer a second repayment amount from the second payment transaction to a lender; and authorizes access to the asset.

In some embodiments, a performed by one or more computing devices for securely controlling access to an asset is provided. The method records in a distributed ledger smart contract transaction that implements a smart contract. The method under control of a controller device associated with the asset, records in the distributed ledger a payment transaction that transfers a payment amount from an access payment transaction to a payment account and sends a payment message to the smart contract. The method allows access to the asset and receives by the smart contract the payment message. The method under control of the smart contract, records in the distributed ledger a second payment transaction to transfer a second payment amount from the payment transaction to a second payment account. In some embodiments, the payment amount transferred to the second payment account is for repayment of a loan to purchase the asset. In some embodiments, the asset is a medical device.

In some embodiments, a controller device for controlling access to an asset is provided. The controller device comprises one or more computer-readable storage mediums storing computer-executable instructions for controlling the controller device and one or more processors for executing the computer-executable instructions stored in the one or more computer-readable storage mediums. The computer-executable instructions control the controller device to receive identification of one or more access payment transactions recorded in a distributed ledger. The computer-executable instructions control the controller device to, in response to receiving an indication of an access to the asset, record in the distributed ledger a first payment transaction that transfers a first payment amount from the one or more access payment transactions to a payment account, send a payment message to a smart contract so that the smart contract can record of one or more second payment transactions to transfer one or more second payment amounts from the first payment transaction to one or more second payment accounts, and authorize access to the asset. In some embodiments, the computer-executable instructions further control the controller device to determine whether the one or more access payment transactions have a combined payment amount that is sufficient to transfer the second payment amounts; and upon determining that the combined payment amount is not sufficient, suppress the recording, sending, and the authorizing so that the asset cannot be accessed unless the combined payment amount is sufficient. In some embodiments, the one or more computer-readable storage mediums stores a private key of a private/public key pair that is used to sign the first payment transaction.

In some embodiments, a method performed by a computing system executing a smart contract recorded in a distributed ledger is provided. The method receives an access message indicating an access to an asset. In response to receiving the access message, the method identifies a payment amount that is to be paid for access to the asset and records in the distributed ledger a payment transaction that transfers a least a portion of the payment amount from a first account to a second account. In some embodiments, the payment transaction is associated with repaying a loan to purchase the asset. In some embodiments, the access message is received from a controller device associated with the asset and that authorizes access to the asset. In some embodiments, the controller device authorizes access to the asset when the first payment account has sufficient funds to transfer the payment amount.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. As used herein, the term “record” means to either directly record a transaction in a distributed ledger or to direct a node of the distributed ledger to record the transaction. The parties (e.g., lenders or borrowers) may be identified by the addresses of their accounts or their public keys. The information recording the blockchain may be encrypted to using the public keys of the parties so that the information can only be view by the parties with the corresponding private keys. Each transaction may be associated with an account that is identified by an account address or a public key of a private/public key pair associated with the account. For example, a payment transaction is associated with a payment account, and an escrow transaction is associated with an escrow account. With the AACS, lenders can loan with terms based on a risk assessment of the market for use of the asset, rather than assessment of past re-payment history of the purchaser. Accordingly, the invention is not limited except as by the appended claims.

I/We claim:

1. A method performed by a computing system for securely controlling repayment of a loan to purchase an asset, the method comprising,
recording a smart contract in a distributed ledger, the smart contract identifying a loan amount for purchase of the asset and terms of a loan agreement;
receiving by the smart contract a plurality of funding messages from lenders, each funding message identifying a funding amount and an escrow transaction that transfer the funding amount to an escrow account;
receiving, by the smart contract from a controller device associated with the asset, a payment message indicating an access to the asset and identifying a payment transaction that transfers a payment amount to a payment account; and
recording by the smart contract in the distributed ledger a repayment transaction that transfers a repayment amount to one or more lenders from the payment amount of the payment transaction.

2. The method of claim 1 wherein the smart contract transitions through a funding state, a funded state, a repaying state, and a paid off state.

3. The method of claim 1 wherein the controller device ensures use of the asset in accordance with terms of the loan agreement.

4. The method of claim 1 wherein the payment account is identified by an address of a private/public key pair of the smart contract.

5. The method of claim 1 wherein the payment account is identified by an address of a private/public key pair of a facilitator who records the smart contract.

6. The method of claim 1 wherein the amounts are represented by tokens that can be exchanged for a currency.

7. The method of claim 1 further comprising when the loan amount is not funded in accordance with terms of the loan agreement, recording by the smart contract in the distributed ledger a refund transaction for each lender that transfers the escrow account a funding amount for that lender to an account of the lender.

8. A method performed by a controller device associated with an asset for coordinating repayment of a loan for purchase of the asset, the method comprising:
accessing configuration information for directing repayment of the loan based on access to the asset;
receiving identification of an access payment transaction of an access payment account;
in response to receiving an indication of access to the asset,
recording in a distributed ledger a payment transaction that transfers a payment amount from the access payment transaction to a payment transaction of a payment account; and
sending a payment message to a smart contract that implements terms of loan agreement for the loan so that the smart contract can direct recording of a repayment transaction to transfer a repayment amount from the payment transaction to lender account of a lender of the loan.

9. The method of claim 8 wherein the configuration information includes a private key of a private/public key pair for the access payment account that is used to sign the payment transaction.

10. The method of claim 8 further comprising, in response to the loan being paid off, activating paid off configuration information wherein the controller device no longer is required to record payment transactions.

11. The method of claim 10 wherein the paid off configuration information enables full control by the borrower of the now-paid off asset.

12. The method of claim 8 further comprising when a payment transaction is identified that includes a payment amount that is sufficient, authorizing access to the asset.

13. The method of claim 12 wherein the authorizing results in disabling of a locking mechanism that prevents access to the asset.

14. The method of claim 8 further comprising when an access payment transaction is not identified that includes a payment amount that is sufficient, not authorizing access to the asset.

15. The method of claim 8 further comprising when an access payment transaction is not identified that includes a payment amount that is sufficient, transitioning to a grace period state and authorizing access to the asset.

16. The method of claim 15 further comprising in response to receiving an indication of a subsequent access to the asset when in the grace period state and when a second access payment transaction is identified that includes a payment amount that is sufficient,
recording in the distributed ledger a second payment transaction that transfers a payment amount from the second access payment transaction the payment account;
sending a second payment message to the smart contract that implements terms of the loan agreement so that the smart contract can record a second repayment transaction to transfer a second repayment amount from the second payment transaction to a lender; and
authorizing access to the asset.

17. A method performed by one or more computing devices for securely controlling access to an asset, the method comprising:
recording in a distributed ledger smart contract transaction that implements a smart contract;
under control of a controller device associated with the asset,
recording in the distributed ledger a payment transaction that transfers a payment amount from an access payment transaction to a payment account; and
sending a payment message to the smart contract; and
allowing access to the asset;
receiving by the smart contract the payment message; and
under control of the smart contract, recording in the distributed ledger a second payment transaction to transfer a second payment amount from the payment transaction to a second payment account.

18. The method of claim 17 wherein the payment amount transferred to the second payment account is for repayment of a loan to purchase the asset.

19. The method of claim 17 wherein the asset is a medical device.

20. A controller device for controlling access to an asset, the controller device comprising:
one or more computer-readable storage mediums storing computer-executable instructions for controlling the controller device to:
receive identification of one or more access payment transactions recorded in a distributed ledger;
in response to receiving an indication of an access to the asset,
record in the distributed ledger a first payment transaction that transfers a first payment amount from the one or more access payment transactions to a payment account;
send a payment message to a smart contract so that the smart contract can record of one or more second payment transactions to transfer one or more second payment amounts from the first payment transaction to one or more second payment accounts; and
authorize access to the asset; and
one or more processors for executing the computer-executable instructions stored in the one or more computer-readable storage mediums.

21. The controller device of claim 20 wherein the computer-executable instructions further control the controller device to:
determine whether the one or more access payment transactions have a combined payment amount that is sufficient to transfer the second payment amounts; and
upon determining that the combined payment amount is not sufficient, suppress the recording, sending, and the authorizing so that the asset cannot be accessed unless the combined payment amount is sufficient.

22. The controller device of claim 20 wherein the one or more computer-readable storage mediums stores a private key of a private/public key pair that is used to sign the first payment transaction.

23. A method performed by a computing system executing a smart contract recorded in a distributed ledger, the method comprising:
receiving an access message indicating an access to an asset;
in response to receiving the access message,
identifying a payment amount that is to be paid for access to the asset; and
recording in the distributed ledger a payment transaction that transfers a least a portion of the payment amount from a first account to a second account.

24. The method of claim 23 wherein the payment transaction is associated with repaying a loan to purchase the asset.

25. The method of claim 23 wherein the access message is received from a controller device associated with the asset and that authorizes access to the asset.

26. The method of claim 25 wherein the controller device authorizes access to the asset when the first payment account has sufficient funds to transfer the payment amount.
